(19) United States
(12) Patent Application Publication
(10) Pub. No.: US 2016/0355352 A1
(43) Pub. Date: Dec. 8, 2016

(54) SYSTEMS AND METHODS FOR CONTROLLING CHECKOUT BELT SPEED

(71) Applicant: Wal-Mart Stores, Inc., Bentonville, AR (US)

(72) Inventors: Nicholaus Adam Jones, Fayetteville, AR (US); Robert James Taylor, Rogers, AR (US); Matthew Allen Jones, Bentonville, AR (US)

(21) Appl. No.: 15/175,335

(22) Filed: Jun. 7, 2016

Related U.S. Application Data
(60) Provisional application No. 62/172,381, filed on Jun. 8, 2015.

(51) Int. Cl. B65G 43/08; G06Q 10/06; G06Q 20/20

(52) U.S. Cl. CPC B65G 43/08; G06Q 20/20; G06Q 10/06398; G05B 2219/25385; B65G 2203/0233; B65G 2203/044

(57) ABSTRACT

Exemplary embodiments provide for controlling a speed of the checkout belt at a point-of-sale terminal. A belt at a point-of-sale terminal is provided for moving an item from a distal end of the POS terminal toward a proximal end of the POS terminal. A drive motor is provided in electrical communication with the POS terminal operative to drive the belt. A sensor is disposed with respect to the belt to sense a distance between the item on the belt and the cashier area of the POS terminal. A processor associated with the POS terminal is provided in communication with the drive motor and the sensor, and is configured to control the drive motor to adjust a speed of the belt in response to the distance between the item and the proximal end of the POS terminal.

### RELATED APPLICATION

This application claims priority to U.S. Provisional Patent Application No. 62/172,381, titled “SYSTEMS AND METHODS FOR CONTROLLING CHECKOUT BELT SPEED,” filed on Jun. 8, 2015, which is hereby incorporated by reference in its entirety.

### BACKGROUND

In retail stores, a belt or conveyor moves items towards a cashier at a point-of-sale terminal. The belt typically moves items at a fixed speed. The belt moving at a fixed speed is inefficient when an item is located farther away from the cashier and no other items are in front of it on the belt. This inefficiency is often realized when a large item is placed on the belt. When the large item is removed from the belt and scanned, the next item on belt takes time to reach the cashier. Moreover, a typical checkout belt is not optimized to move items quickly towards a cashier. The inefficiencies caused by the fixed speed belt impacts a customer's checkout experience, and the amount of time a customer spends at a point-of-sale terminal for a checkout transaction.

### SUMMARY

In one embodiment, a system for controlling a speed of a belt at a point-of-sale terminal is provided. The system includes a belt at a point-of-sale (POS) terminal for moving an item from a distal end of the POS terminal toward a proximal end of the POS terminal. The proximal end of the POS terminal is closer to a cashier area than the distal end of the POS terminal. The system also includes a drive motor in electrical communication with the POS terminal operative to drive the belt, and a sensor disposed with respect to the belt to sense a distance between the item on the belt and the cashier area of the POS terminal. The system also includes a processor associated with the POS terminal, where the processor is in communication with the drive motor and the sensor, and it is configured to control the drive motor to adjust a speed of the belt in response to the distance between the item and the proximal end of the POS terminal.

In another embodiment, a method for controlling a speed of a belt at a point-of-sale terminal is provided. The method includes sensing, via a sensor disposed with respect to a belt, a distance between an item on the belt at a point-of-sale (POS) terminal and a cashier area of the POS terminal. The proximal end of the POS terminal is closer to the cashier area than the distal end of the POS terminal. The belt is for moving the item from the distal end of the POS terminal toward the proximal end of the POS terminal via a drive motor in electrical communication with the POS terminal operative to drive the belt. The method also includes controlling, via a processor associated with the POS terminal, the drive motor to adjust the speed of the belt in response to the distance between the item and the proximal end of the POS terminal.

In yet another embodiment, a non-transitory machine-readable medium is provided for storing instructions executable by a processing device, where execution of the instructions causes the processing device to implement a method for controlling a speed of a belt at a point-of-sale terminal. The method includes sensing, via a sensor disposed with respect to a belt, a distance between an item on the belt at a point-of-sale (POS) terminal and a cashier area of the POS terminal. The proximal end of the POS terminal is closer to the cashier area than the distal end of the POS terminal. The belt is for moving the item from the distal end of the POS terminal toward the proximal end of the POS terminal via a drive motor in electrical communication with the POS terminal operative to drive the belt. The method also includes controlling, via a processor associated with the POS terminal, the drive motor to adjust the speed of the belt in response to the distance between the item and the proximal end of the POS terminal.

In another embodiment, a system for controlling a speed of a belt at a point-of-sale terminal is provided. The system includes means for sensing a distance between an item on the belt at a point-of-sale (POS) terminal and a cashier area of the POS terminal. The proximal end of the POS terminal is closer to the cashier area than the distal end of the POS terminal, and where the belt is for moving the item from the distal end of the POS terminal toward the proximal end of the POS terminal via a drive motor in electrical communication with the POS terminal operative to drive the belt. The system also includes means for controlling the drive motor to adjust the speed of the belt in response to the distance between the item and the proximal end of the POS terminal.

### BRIEF DESCRIPTION OF DRAWINGS

Some embodiments are illustrated by way of example in the accompanying drawings and should not be considered as a limitation of the invention:

FIG. 1A schematically depict a point-of-sale terminal with a checkout belt implementing a system for controlling checkout belt speed, according to an example embodiment;

FIG. 1B schematically depict a point-of-sale terminal with a checkout belt implementing a system for controlling checkout belt speed, according to an example embodiment;

FIG. 1C schematically depicts a point-of-sale terminal with a checkout belt implementing a system for sensing a distance between an item and a cashier area and/or a dimension of an item, according to an example embodiment;

FIG. 2 is a block diagram showing a belt speed control system, according to an example embodiment;

FIG. 3 is a flowchart showing an example method for controlling checkout belt speed, according to an example embodiment;

FIG. 4 illustrates a system for controlling a checkout belt speed, according to an example embodiment;

FIG. 5 illustrates a network diagram depicting a system for controlling checkout belt speed, according to an example embodiment; and

FIG. 6 is a block diagram of an example computing device that may be used to implement exemplary embodiments of the belt speed control system described herein.

### DESCRIPTION OF EXEMPLARY EMBODIMENTS

Systems, methods, and computer readable medium are provided for controlling a speed of a belt at the point-of-sale terminal. The belt speed control system described herein provides a belt at a POS terminal, where the speed of the belt can be adjusted to enable a cashier to perform checkout transactions efficiently. In example embodiments, the speed of the belt is automatically controlled via, for example, a processor and a sensor. As a non-limiting example, the sensor detects the distance between an item and the cashier area, and when the items are farther away from the cashier area, the speed of the belt is automatically increased to move the items faster towards the cashier area. In some embodiments, the speed of the belt can be controlled manually by a user via one or more actuation members or input devices provided at the POS terminal that enables a user to vary the speed of the belt. In this manner, the belt speed control system can increase cashier productivity and efficiency.

Exemplary embodiments, provide a belt at a point-of-sale (POS) terminal for moving an item from a distal end of the POS terminal toward a proximal end of the POS terminal, where the proximal end of the POS terminal is closer to a cashier area and/or item scanner than the distal end of the POS terminal. A drive motor is in electrical communication with the POS terminal to drive the belt. A sensor is disposed with respect to the belt to sense a distance between the item on the belt and the cashier area of the POS terminal. A processor is provided in communication with the drive motor and the sensor, and is configured to control the drive motor to adjust a speed of the belt in response to the distance between the item and the cashier area of the POS terminal.

As used herein, the cashier area is an area where a cashier operates the POS terminal and performs transactions, for example, by scanning items for checkout (e.g., using a bar code reader or other suitable reader), placing items on another conveyor or belt or in a bag, and accepting payment for the items from a customer.

The following description is presented to enable any person skilled in the art to create and use a computer system configuration and related method and article of manufacture to control a speed of a belt at a POS terminal. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

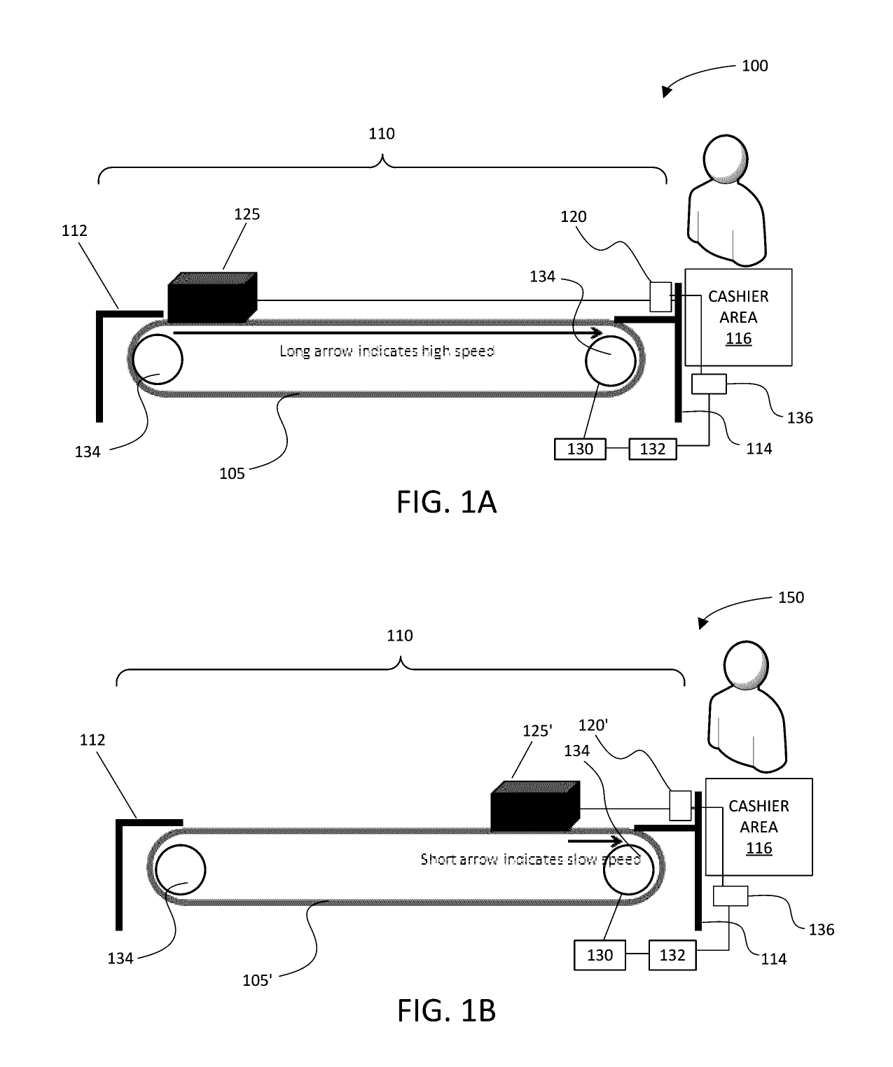

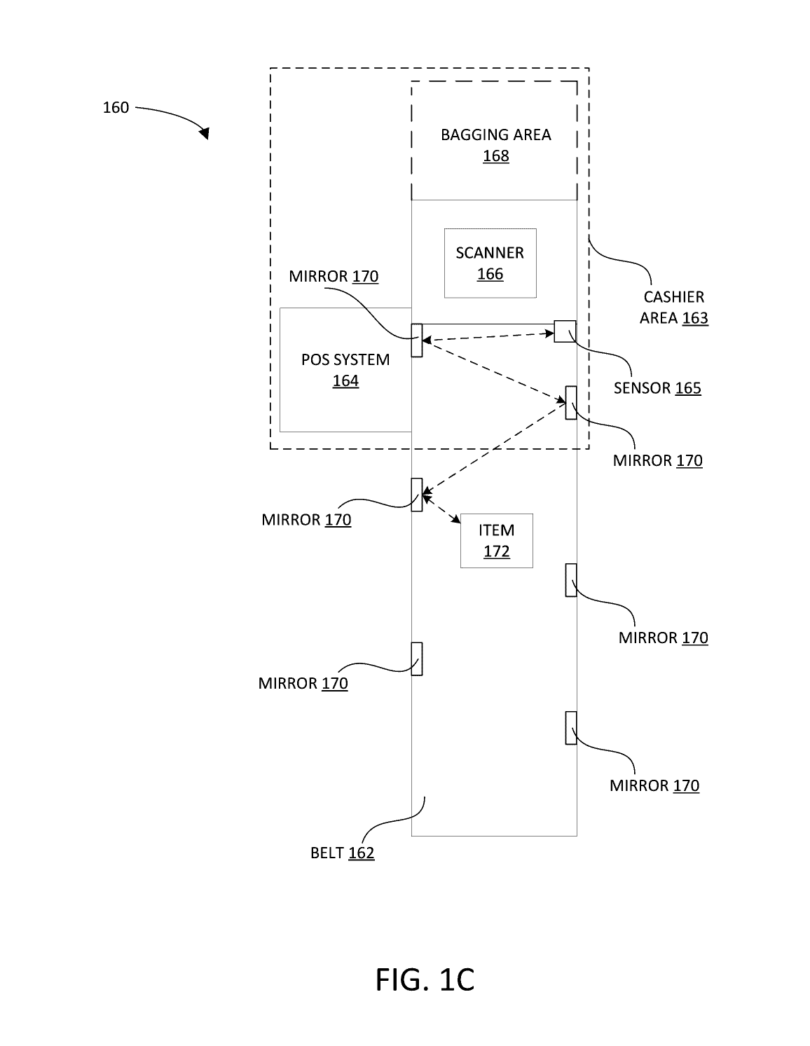

FIG. 1A schematically depicts a point-of-sale (POS) terminal with a checkout belt implementing example system 100 for controlling checkout belt speed, according to an example embodiment. System 100 includes POS terminal 110 with distal end 112 and proximal end 114, where the proximal end is closer to the cashier area 116. The proximal end 114 is also the end of the POS terminal 110 that is closer to a reader/scanner, with which the cashier scans items or enters item codes to perform a checkout transaction. The POS terminal 110 includes endless belt 105 for moving item 125 from the distal end 112 to the proximal end 114. Sensor 120 is also included at POS terminal 110 to sense a distance between the item 125 and cashier area 116 or scanner. The POS terminal also includes a drive motor 130 to drive the belt 105 using a pair of rollers 134 disposed at each end of the belt 105. One or both of the rollers 134 may be electrically and/or mechanically coupled to the drive motor 130 to facilitate rotation of one or both of the rollers 134 and to enable movement of the belt 105 in response to the rotation of one or both of the rollers 134. A processor 136 associated with the POS terminal 110 is in communication with the drive motor 130 and the sensor 120. The processor may be included with the POS terminal 110 or it may be separate from the POS terminal 110. The POS terminal 110 may also include a modulation unit 132 to provide variable power to the drive motor 130 (e.g., to control a speed at which the motor rotates one or both of the rollers 134; thereby controlling a speed of the belt 105). The processor 136 is configured to control the drive motor 130 via the modulation unit 132 to adjust the speed of the belt 105 based on, for example, the distance between the item 125 and the cashier area 116 as determined via the sensor 120.

As shown in FIG. 1A, the item 125 is located near the distal end 112 of the POS terminal 110. The sensor 120 senses the distance between the item 125 and the cashier area 116, and communicates the distance to the processor. In an example embodiment, the processor determines that the item 125 is farther away from the cashier area 116, and controls the drive motor 130 to increase the speed of the belt 105 so that the item 125 moves towards the cashier area 116 faster. In exemplary embodiments, the sensor 120 can include a transmitter and a receiver. The transmitter can emit electromagnetic or acoustic radiation along the belt 105 towards a distal end 112 of the belt 105. When the electromagnetic or acoustic radiation impinges upon the item 125 being carried by the belt 105, a reflected signal can radiate towards the receiver of the sensor 120. In exemplar embodiments, the system 100 can determine a distance between the cashier area 116 or scanner and the item 125 based on a time that elapses between the transmission of the radiation and the receipt of the reflected signal.

FIG. 1B schematically depicts a point-of-sale terminal with a checkout belt implementing example system 150 for controlling checkout belt speed, according to an example embodiment. As shown in FIG. 1B, the item 125′ is located near the proximal end 114 of the POS terminal 110. The sensor 120′ senses the distance between the item 125′ and the cashier area 116, and communicates the distance to the processor. In an example embodiment, the processor 136 determines that the item 125′ is closer to the cashier area 116 or scanner, and controls the drive motor 130, for example via the modulation unit 132, to decrease the speed of the belt 105′ so that the item 125′ moves towards the cashier area 116 or scanner at a slower speed. Some embodiments may include additional sensors, for example, a sensor for detecting that an item has reached the cashier area, and in response, stops the belt to prevent the item from moving off the belt into the cashier area.

In some embodiments, the sensor is a laser-based distance measurement mechanism. In other embodiments, the sensor can be any mechanism to measure a distance between the item and the cashier area. In an example embodiment, the POS terminal may include an array of sensors across the width of the belt to measure a distance between one or more items and the cashier area, so that a small item placed on the belt can be sensed by the array of sensors and/or the sensors can be used to determine the closest item to the cashier area or scanner. An example embodiment may include a plurality of reflective surfaces, such as mirrors, at a distal end of the POS terminal. The plurality of reflective surfaces may be arranged in an overlapping pattern or a zigzag pattern covering the width of the belt, so that the light beam from a laser-based sensor is reflected across the belt to sense large and small items.

FIG. 1C schematically depicts a POS terminal with a checkout belt implementing an example system 160 for sensing a distance between an item and a cashier area 163, according to an example embodiment. As shown in FIG. 1C, the system 160 can include an endless checkout belt 162 for moving items from a distal end of POS terminal to a proximal end of POS terminal that is located closer to a cashier area 163 or scanner 166. The item scanner/reader 166 can be used to read item codes (e.g., bar codes) on an item. The system 160 can also include a POS system 164 for performing various transactions and an optional bagging area 168 for a cashier to place items in a bag. The POS system 164, the scanner 166, and the optional bagging area 168 may be collectively referred to herein as a cashier area 163, as shown in FIG. 1C. The belt 162 can include a plurality of reflective surfaces or mirrors 170 along the belt 162 in a particular pattern. The mirrors 170 are configured so that a light or laser beam from sensor(s) 165 is reflected across the width of the belt to sense the presence of an item on the belt 162. For example, as shown in FIG. 1C, the mirrors 170 are arranged along the belt 162 to sense item 172 via the return-reflection of a light or laser beam from the item 172. The path of the light or laser beam is illustrated via the dashed-arrows. In example embodiments, data indicating the speed of the belt is collected from the sensors. Such data is used to determine cashier performance metrics based on, for example, the speed of the belt during a period of time that the cashier operates the POS terminal to perform checkout transactions. The arrangement of the mirrors with respect to the sensor(s) 165 can also allow the system 160 to estimate a size of an item base on for example, a speed of the belt and a duration for which the time between the transmitted and reflected signal remains constant (e.g., Size=Speed*Duration). This can allow the system to generate one or more metrics associated with a cashier performance in terms of the size of the items being scanned (e.g., feet/meters of items scanned per minute). In some embodiments, the metrics associated with the cashier performance are provided in a report. The report may be displayed in a user interface or provided in a document (such as word, excel, XML, or any other suitable application).

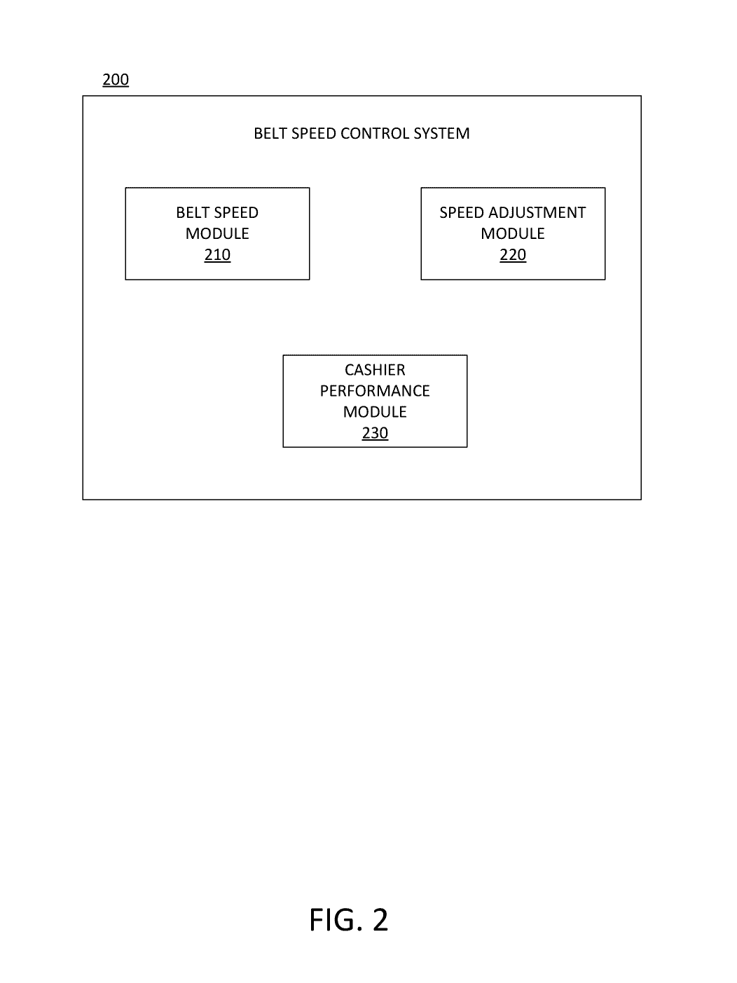

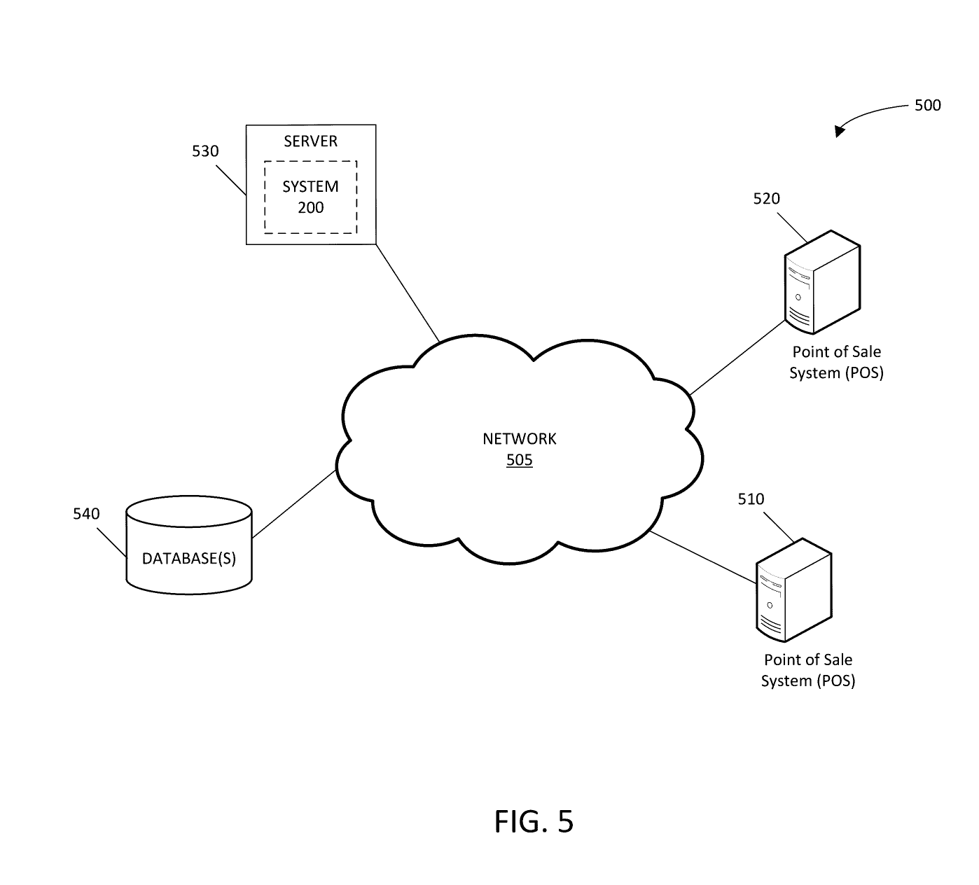

FIG. 2 is a block diagram showing example modules 210, 220, 230 that can be included in a belt speed control system 200, according to an example embodiment. The modules may be implemented using a device and/or a system, such as but not limited to, POS systems 510, 520 described below in relation to FIG. 5. The modules may include various circuits, circuitry, and one or more software components, programs, applications, apps or other units of code base or instructions configured to be executed by one or more processors included in POS systems 510, 520. In other embodiments, one or more of modules 210, 220, 230 may be included in server 530, while others of the modules 210, 220, 230 can be provided in POS systems 510, 520. Although modules 210, 220, 230 are shown as distinct modules in FIG. 2, it should be understood that the procedures and/or computations performed using modules 210, 220, 230 may be implemented using fewer or more modules than illustrated. It should be understood that any of modules 210, 220, 230 may communicate with one or more components included in system 500, such as but not limited to, database(s) 540, server 530, or POS systems 510, 520. In the example of FIG. 2, the belt speed control system 200 includes a belt control module 210, a speed adjustment module 220, and a cashier performance module 230.

The belt control module 210 may be a hardware-implemented module that may be configured to operate a checkout belt at a POS terminal in a store. For example, the belt control module 210 may be configured to operate a drive motor configured to move an item on the checkout belt toward a cashier area at the POS terminal. The belt control module 210 can also be configured to provide means for moving the belt to move an item from the distal end of the POS terminal toward the proximal end of the POS terminal via a drive motor in electrical communication with the POS terminal operative to drive the belt.

The speed adjustment module 220 may be a hardware-implemented module that may be configured to manage and control the speed of the checkout belt. For example, the speed adjustment module 220 may be configured to sense a distance between an item on the belt and the cashier area at the POS terminal. The speed adjustment module 220 can also be configured to provide means for sensing a distance between an item on the belt at a POS terminal and a cashier area of the POS terminal.

The cashier performance module 230 may be a hardware-implemented module that may be configured to manage and analyze cashier performance metrics. For example, the cashier performance module 210 may be configured to determine cashier performance metrics based on the speed of the checkout belt over a period of time while the cashier is operating the POS terminal and/or a size of the items being scanned with respect to time (e.g., feet/meters of items scanned per minute). The cashier performance module 230 can also be configured to provide means for determining cashier performance metrics for a cashier based on data related to the speed of the belt over a period of time.

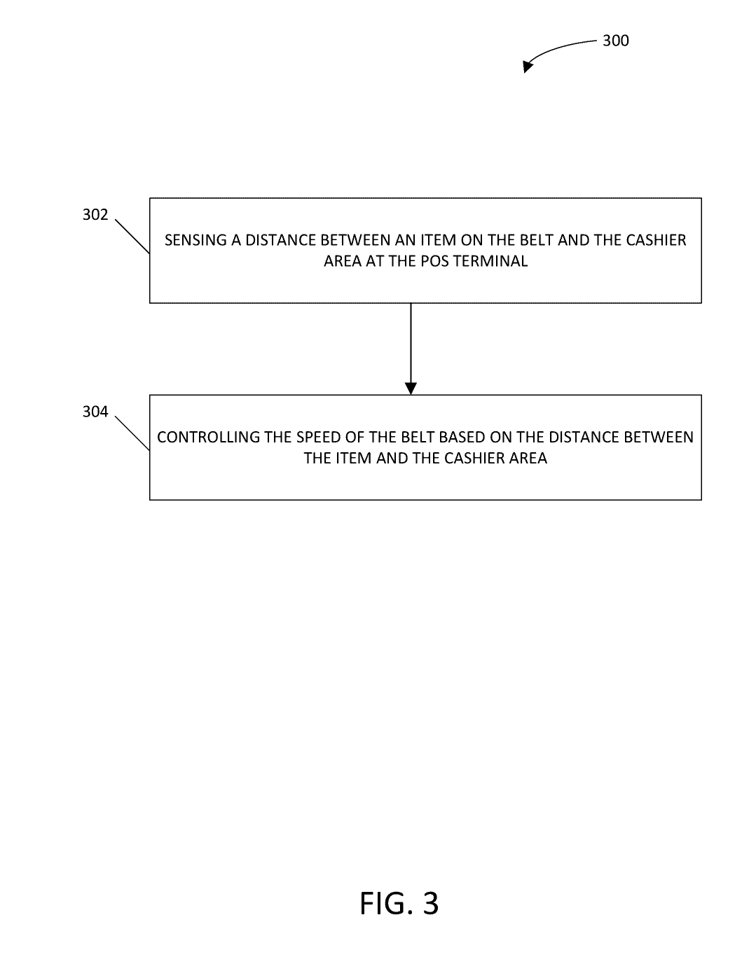

FIG. 3 is a flowchart showing an example method 300 for controlling checkout belt speed, according to an example embodiment. The method 300 may be performed using the example belt speed control system 200 shown in FIG. 2.

In operation 302, the speed adjustment module 220 senses a distance between an item on the belt and the cashier area at the POS terminal. In an example embodiment, the belt control system 210 moves the belt at the POS terminal to move an item from a distal end of the POS terminal toward a proximal end of the POS terminal, where the proximal end is closer to the cashier area or scanner than the distal end of the POS terminal. As described above, a drive motor is coupled to the POS terminal, such that it is in electrical communication with the POS terminal, and operates to drive the belt. In some embodiments, the belt control module 210 is configured to move the belt via the drive motor.

In operation 304, the speed adjustment module 220 controls the speed of the belt based on the distance between the item on the belt and the cashier area at the POS terminal. In an example embodiment, a processor is in communication with the drive motor and the sensor, and is configured to control the drive motor to adjust a speed of the belt in response to the distance between the item and the cashier area of the POS terminal. In some embodiments, the processor is configured to automatically increase the speed of the belt when the item on the belt is farther away from the proximal end of the POS terminal than the distal end of the POS terminal.

Some embodiments, include a modulation unit coupled to the drive motor (via an electrical communication) to provide variable power to the drive motor for moving the belt at different speeds. The modulation unit is also in communication with the processor, and the processor is configured to adjust the speed of the belt by wirelessly transmitting communications to the modulation unit to adjust the power provided to the drive motor for moving the belt at variable speeds. In some embodiments, the speed of the belt may range from about 0 meters per second to about 1 meter per second.

Some embodiments include an actuation member or input device, such as a button, a switch, a dial, or a touch-screen interface, in electrical communication with the drive motor and coupled to the POS terminal. Actuating the actuation member or interacting with the input device enables a cashier to manually adjust the speed of the belt. In this manner, the cashier can increase the speed of the belt or decrease the speed of the belt. An example embodiment may include multiple actuation members for varying speed levels, for example, slow speed, slow-medium speed, medium speed, medium-fast speed, and fast speed.

In some embodiments, the processor is configured to determine the speed of the belt over a period of time, and a database, for example database(s) 540 shown in FIG. 5, stores data indicating the speed of the belt over a period of time for a cashier operating the POS terminal. In certain embodiments, the processor is configured to determine cashier performance metrics based on analyzing the speed of the belt over a period of time. The cashier performance metrics may indicate a cashier's efficiency in performing a checkout transaction. The speed of the belt over a period of time while the cashier is operating the POS terminal may indicate how quickly a cashier scans the items on the belt. In an example embodiment, the processor is configured to determine a number of items scanned by a cashier during the period of time, and is configured to determine an average belt speed for the cashier over a period of time.

In some embodiments, the processor is configured to calculate a size of the item on the belt. The size of the item may be calculated based on data from the sensor as described herein. In an example embodiment, the cashier performance metrics is based on the number of items scanned over a period of time, and a size of the item scanned. In this manner, the belt speed control system 200 takes into consideration the size of the item scanned, not only the number of items scanned, when determining cashier performance metrics. Scanning large items takes a longer time than a smaller item, however, traditionally cashier performance metrics do not account for the longer time it takes to process a larger item.

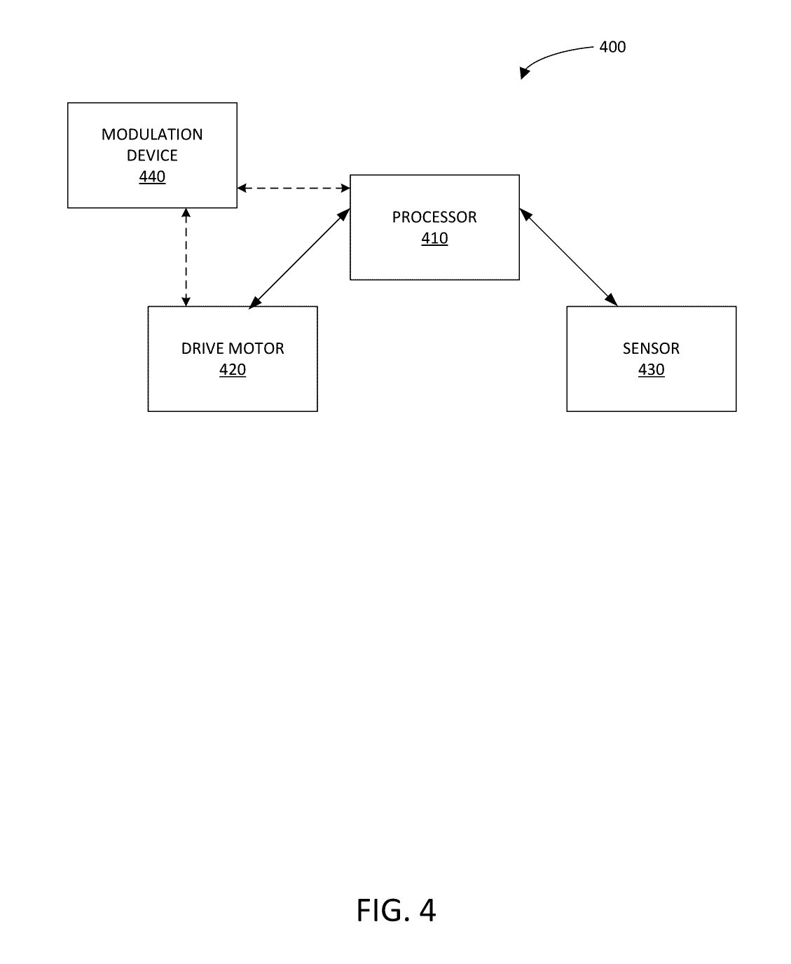

FIG. 4 illustrates a system 400 for controlling a checkout belt speed, according to an example embodiment. System 400 includes a processor 410, drive motor 420 and sensor 430. The processor 410 is in communication with the drive motor 420 and the sensor 430. In some embodiments, the processor 410 can be in communication with the drive motor 420 via a modulation device 440. As described above, the sensor 430 transmits communications to the processor 410 containing data related to the distance between the item on the belt and the cashier area. As described above, the processor 410 transmits communications to the drive motor 420 to adjust the speed of the belt based on the distance detected by the sensor 430 between the item on the belt and the cashier area.

In this manner, the system and methods described herein control the speed of a belt at a POS terminal. The systems and methods described herein provide for varying the speed of the belt so that items on the belt can be moved faster or slower towards the cashier area. These features help increase cashier productivity and efficiency in performing checkout transactions. It also provides a better checkout experience for a customer by speeding up the checkout transaction. The systems and methods described herein also provides for determining cashier performance metrics based on the speed of the belt over a period of time.

FIG. 5 illustrates a network diagram depicting a system 500 for controlling a speed of a checkout belt at a POS terminal, according to an example embodiment. The system 500 can include a network 505, multiple point-of-sale (POS) systems, such as POS system 510, POS system 520, a server 530, and database(s) 540. Each of POS systems 510, 520, server 530, and database(s) 540 is in communication with the network 505.

In an example embodiment, one or more portions of network 505 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

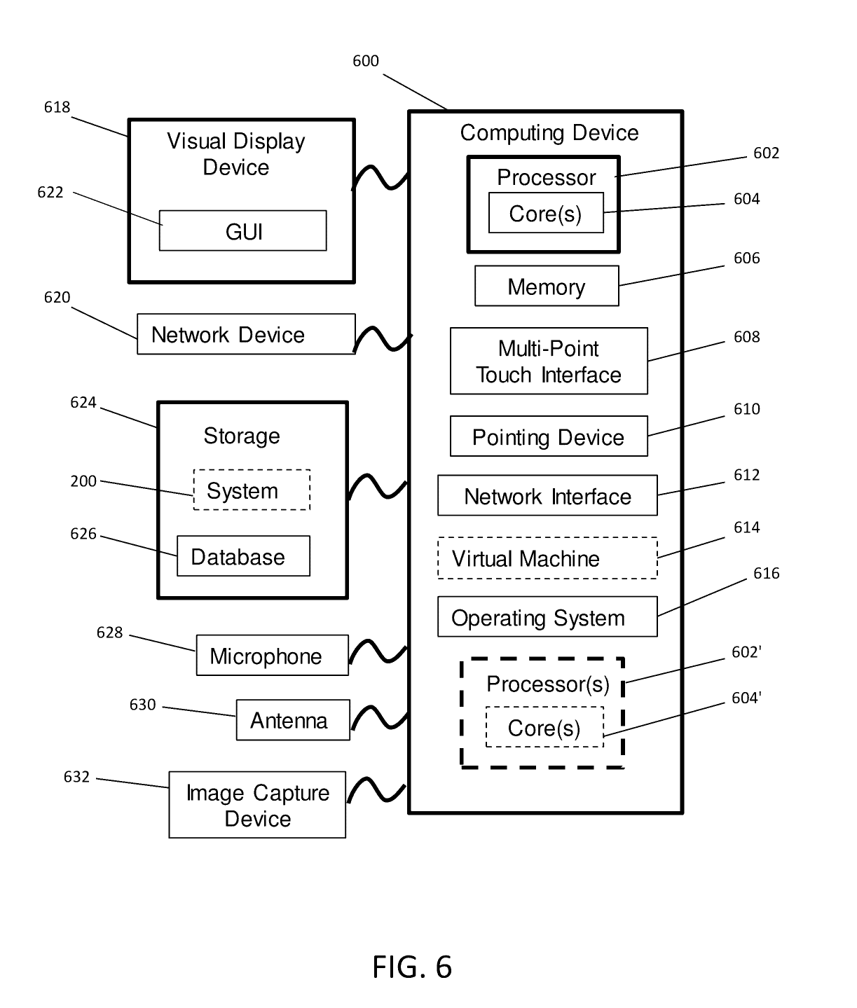

The POS system 510, 520 may comprise, but is not limited to, cash registers, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, network PCs, mini-computers, smartphones, tablets, netbooks, and the like. The POS system 510, 520 is part of a store infrastructure and aids in performing various transactions related to sales and other aspects of a store. Being part of a store's infrastructure, the POS system 510, 520 may be installed within the store or they may be installed or operational outside of the store. For example, the POS system 510, 520 may be a mobile device that a store employee can use outside of the store to perform transactions or other activities. In another example, the POS system 510, 520 may be a kiosk installed outside the store. Similarly, the POS system 510, 520 may be a mobile device that can be used within the store, and is not physically installed or attached to one particular location within the store. The POS system 510, 520 can include one or more components described in relation to computing device 600 shown in FIG. 6.

The POS system 510, 520 may also include various external or peripheral devices to aid in performing sales transactions and other duties. Examples of peripheral devices include, but are not limited to, barcode scanners, cash drawers, monitors, touch-screen monitors, clicking devices (e.g., mouse), input devices (e.g., keyboard), receipt printers, coupon printers, payment terminals, and the like. Examples of payment terminals include, but are not limited to, card readers, pin pads, signature pads, signature pens, Square™ registers, LevelUp™ platform, cash or change deposit devices, cash or change dispensing devices, coupon accepting devices, and the like.

Each of the POS systems 510, 520 may connect to network 505 via a wired or wireless connection. Each of the POS systems 510. 520 may include one or more applications or systems such as, but not limited to, a sales transaction application, a cashier performance application, a belt speed control system, and the like. In an example embodiment, the POS system 510, 520 may perform all the functionalities described herein.

In other embodiments, the belt speed control system may be included on POS system 510, 520, and the server 530 performs the functionalities described herein. In yet another embodiment, the POS system 510, 520 may perform some of the functionalities, and server 530 performs the other functionalities described herein. For example, POS system 510, 520 may sense the distance between the item and the cashier area, while server 530 controls the drive motor to adjust the speed of the belt. In some embodiments, the server 530 may also determine cashier performance based on the speed of the belt and the number of items scanned.

Each of the server 530, and database(s) 540, is connected to the network 505 via a wired connection. Alternatively, one or more of the server 530, and database(s) 540 may be connected to the network 505 via a wireless connection. Server 530 comprises one or more computers or processors configured to communicate with POS system 510, 520, and/or database(s) 530 via network 505. Server 530 hosts one or more applications or websites accessed by POS system 510, 520 and/or facilitates access to the content of database(s) 540. Server 530 also may include system 200 described herein. Database(s) 540 comprise one or more storage devices for storing data and/or instructions (or code) for use by server 530, and/or POS system 510, 520. Database(s) 540 and server 530 may be located at one or more geographically distributed locations from each other or from POS system 510, 520. Alternatively, database(s) 540 may be included within server 530.

FIG. 6 is a block diagram of an exemplary computing device 600 that may be used to implement exemplary embodiments of the belt speed control system 200 described herein. The computing device 600 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 606 included in the computing device 600 may store computer-readable and computer-executable instructions or software for implementing exemplary embodiments of the belt speed control system 200. The computing device 600 also includes configurable and/or programmable processor 602 and associated core(s) 604, and optionally, one or more additional configurable and/or programmable processor(s) 602′ and associated core(s) 604′ (for example, in the case of computer systems having multiple processors/cores), for executing computer-readable and computer-executable instructions or software stored in the memory 606 and other programs for controlling system hardware. Processor 602 and processor(s) 602′ may each be a single core processor or multiple core (604 and 604′) processor.

Virtualization may be employed in the computing device 600 so that infrastructure and resources in the computing device may be shared dynamically. A virtual machine 614 may be provided to handle a process running on multiple processors so that the process appears to be using only one computing resource rather than multiple computing resources. Multiple virtual machines may also be used with one processor.

Memory 606 may include a computer system memory or random access memory, such as DRAM, SRAM, EDO RAM, and the like. Memory 606 may include other types of memory as well, or combinations thereof.

A user may interact with the computing device 600 through a visual display device 618, such as a computer monitor, which may display one or more graphical user interfaces 622, that may be provided in accordance with exemplary embodiments. The computing device 600 may include other I/O devices for receiving input from a user, for example, a keyboard or any suitable multi-point touch interface 608, a pointing device 610 (e.g., a mouse), a microphone 628, and/or an image capturing device 632 (e.g., a camera or scanner). The multi-point touch interface 608 (e.g., keyboard, pin pad, scanner, touch-screen, etc.) and the pointing device 610 (e.g., mouse, stylus pen, etc.) may be coupled to the visual display device 618. The computing device 600 may include other suitable conventional I/O peripherals.

The computing device 600 may also include one or more storage devices 624, such as a hard-drive, CD-ROM, or other computer readable media, for storing data and computer-readable instructions and/or software that implement exemplary embodiments of the belt speed control system 200 described herein. Exemplary storage device 624 may also store one or more databases for storing any suitable information required to implement exemplary embodiments. For example, exemplary storage device 624 can store one or more databases 626 for storing information, such as belt speed, items scanned, size of items, sensor information, cashier information, cashier performance metrics and/or any other information to be used by embodiments of the system 200. The databases may be updated manually or automatically at any suitable time to add, delete, and/or update one or more data items in the databases.

The computing device 600 can include a network interface 612 configured to interface via one or more network devices 620 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. In exemplary embodiments, the computing device 600 can include one or more antennas 630 to facilitate wireless communication (e.g., via the network interface) between the computing device 600 and a network. The network interface 612 may include a built-in network adapter, network interface card, PCMCIA network card, card bus network adapter, wireless network adapter, USB network adapter, modem or any other device suitable for interfacing the computing device 600 to any type of network capable of communication and performing the operations described herein. Moreover, the computing device 600 may be any computer system, such as a workstation, desktop computer, server, laptop, handheld computer, tablet computer (e.g., the iPad™ tablet computer), mobile computing or communication device (e.g., the iPhone™ communication device), point-of sale terminal, internal corporate devices, or other form of computing or telecommunications device that is capable of communication and that has sufficient processor power and memory capacity to perform the operations described herein.

The computing device 600 may run any operating system 616, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 616 may be run in native mode or emulated mode. In an exemplary embodiment, the operating system 616 may be run on one or more cloud machine instances.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A system for controlling a speed of a belt at a point-of-sale terminal, the system comprising:
a belt at a point-of-sale (POS) terminal for moving an item from a distal end of the POS terminal toward a proximal end of the POS terminal, wherein the proximal end of the POS terminal is closer to a cashier area than the distal end of the POS terminal;
a drive motor in electrical communication with the POS terminal operative to drive the belt;
a sensor disposed with respect to the belt to sense a distance between the item on the belt and the cashier area of the POS terminal; and
a processor associated with the POS terminal, the processor in communication with the drive motor and the sensor, and configured to control the drive motor to adjust a speed of the belt in response to the distance between the item and the proximal end of the POS terminal.

2. The system of claim 1, further comprising:
a modulation unit in communication with the processor coupled to the drive motor.

3. The system of claim 2, wherein the processor is configured to adjust the speed of the belt by wirelessly transmitting communications to the modulation unit to adjust a voltage provided to the drive motor for moving the belt.

4. The system of claim 1, further comprising:
an input device in electrical communication with the drive motor and coupled to the POS terminal, wherein actuation of the input device enables a cashier to manually adjust the speed of the belt.

5. The system of claim 1, further comprising a database in communication with the processor,
wherein the processor is configured to determine the speed of the belt over a period of time, and
the database stores data indicating the speed of the belt over a period of time for a cashier operating the POS terminal.

6. The system of claim 5, further comprising an additional processor in communication with the database, and configured to determine cashier performance metrics based on the speed of the belt over the period of time.

7. The system of claim 5, wherein the additional processor is configured to determine a number of items scanned by a cashier during a period of time, and is configured to determine an average belt speed for the cashier.

8. The system of claim 1, wherein the sensor is a laser-based measurement mechanism.

9. The system of claim 1, wherein the processor is further configured to calculate a size of the item on the belt.

10. The system of claim 1, wherein the processor is configured to automatically increase the speed of the belt when the item on the belt is farther away from the proximal end of the POS terminal than the distal end of the POS terminal.

11. A method for controlling a speed of a belt at a point-of-sale terminal, the method comprising:
sensing, via a sensor disposed with respect to a belt, a distance between an item on the belt at a point-of-sale (POS) terminal and a cashier area of the POS terminal, a proximal end of the POS terminal being closer to the cashier area than a distal end of the POS terminal, wherein the belt is for moving the item from the distal end of the POS terminal toward the proximal end of the POS terminal via a drive motor in electrical communication with the POS terminal operative to drive the belt; and
controlling, via a processor associated with the POS terminal, the drive motor to adjust the speed of the belt in response to the distance between the item and the proximal end of the POS terminal.

12. The method of claim 11, further comprising:
wirelessly transmitting communications from the processor to a modulation unit coupled to the drive motor to adjust the speed of the belt; and
adjusting a voltage provided to the drive motor for moving the belt via the modulation unit.

13. The method of claim 11, further comprising:
enabling a cashier to manually adjust the speed of the belt via actuation of a input device coupled to the POS terminal and in electrical communication with the drive motor.

14. The method of claim 11, further comprising:
determining, via the processor, the speed of the belt over a period of time, and
storing, in a database in communication with the processor, data related to the speed of the belt over the period of time for a cashier operating the POS terminal.

15. The method of claim 14, further comprising:
determining cashier performance metrics for the cashier based on data related to the speed of the belt over the period of time.

16. The method of claim 11, wherein automatically adjusting the speed of the belt comprises automatically increasing the speed of the belt when the item on the belt is farther away from the proximal end of the POS terminal than the distal end of the POS terminal.

17. A non-transitory machine-readable medium storing instructions executable by a processing device, wherein execution of the instructions causes the processing device to implement a method for controlling a speed of a belt at a point-of-sale terminal, the method comprising:
sensing, via a sensor disposed with respect to a belt, a distance between an item on the belt at a point-of-sale (POS) terminal and a cashier area of the POS terminal, a proximal end of the POS terminal being closer to the cashier area than a distal end of the POS terminal, wherein the belt is for moving the item from the distal end of the POS terminal toward the proximal end of the POS terminal via a drive motor in electrical communication with the POS terminal operative to drive the belt; and
controlling, via the processor device, the drive motor to adjust the speed of the belt in response to the distance between the item and the proximal end of the POS terminal.

18. The non-transitory machine-readable medium of claim 17, further comprising:
wirelessly transmitting communications from the processing device to a modulation unit coupled to the drive motor to adjust the speed of the belt; and
causing an adjustment in a voltage provided to the drive motor for moving the belt via the modulation unit.

19. The non-transitory machine-readable medium of claim 17, further comprising:
determining the speed of the belt over a period of time, and
storing, in a database in communication with the processing device, data related to the speed of the belt over a period of time for a cashier operating the POS terminal.

20. The non-transitory machine-readable medium of claim 17, further comprising:
determining cashier performance metrics for a cashier based on data related to the speed of the belt over a period of time.

21. A system for controlling a speed of a belt at a point-of-sale terminal, the system comprising:
means for sensing a distance between an item on the belt at a point-of-sale (POS) terminal and a cashier area of the POS terminal, a proximal end of the POS terminal being closer to the cashier area than a distal end of the POS terminal, wherein the belt is for moving the item from the distal end of the POS terminal toward the proximal end of the POS terminal via a drive motor in electrical communication with the POS terminal operative to drive the belt; and
means for controlling the drive motor to adjust the speed of the belt in response to the distance between the item and the proximal end of the POS terminal.
